(19) United States
(12) Patent Application Publication
(10) Pub. No.: US 2019/0305329 A1
(43) Pub. Date: Oct. 3, 2019

(54) Method for Manufacturing a Separator Plate for a Fuel Cell, Separator Plate and Intermediate Product for a Separator Plate

(71) Applicants: Daimler AG, Stuttgart (DE); Karl Worwag Lack- und Farbenfabrik GmbH & Co. KG, Stuttgart (DE)

(72) Inventors: Falk Ullmann, Koengen (DE); Helge Warta, Ditzingen (DE)

(21) Appl. No.: 16/348,828

(22) PCT Filed: Dec. 19, 2017
(86) PCT No.: PCT/IB2017/001586

§ 371 Date: May 9, 2019

(30) Foreign Application Priority Data
Dec. 22, 2016 (DE) 102016015318.0

(51) Int. Cl. H01M 8/0258; H01M 8/0221; H01M 8/0226

(52) U.S. Cl. CPC H01M 8/0258; H01M 2008/1095; H01M 8/0226; H01M 8/0221

(57) ABSTRACT

The invention relates to a method for manufacturing a separator plate (12) for a fuel cell, wherein a curable and electrically conductive material (20) is applied to a substrate material (14). A flow field (34) for a reactant which can be supplied to the fuel cell is formed in the material (20). After the flow field (34) is formed, the material (20) is cured. The invention also relates to a separator plate (12) for a fuel cell and an intermediate product for a separator plate (12).

The invention relates to a method for manufacturing a separator plate for a fuel cell. Moreover, the invention relates to a separator plate for a fuel cell as can come into use in a fuel cell stack, and an intermediate product for such a separator plate.

The principle construction of a polymer electrolyte membrane fuel cell—PEMFC for short—is as follows. The PEMFC contains a membrane electrode assembly—MEA for short, which is constructed from an anode, a cathode and a polymer electrolyte membrane (also referred to as ionomer membrane)—PEM for short—arranged therebetween. The MEA is, for its part, in turn arranged between two separator plates, wherein a separator plate comprises channels for the distribution of fuel and the other separator plate comprises channels for the distribution of oxidizing agent, and wherein the channels are facing the

MEA. The channels form a channel structure, a so-called flow-field. The electrodes, anode and cathode can in particular be formed as gas diffusion electrodes—GDE for short. These have the function of dissipating the electric current generated in the electrochemical reaction (for example 2 H₂+O₂→2 H₂O) and of letting the reactants, educts and products diffuse. A GDE consists of at least one gas diffusion layer or gas diffusion ply—GDL for short—and a catalyst layer, which is facing the PEM and at which the electrochemical reaction takes place. The GDE can further also comprise a gas distribution layer, which adjoins the gas diffusion layer and which, in the PEMFC, faces a separator plate. Gas diffusion layer and gas distribution layer differ from one another above all in their pore size and therefore in the type of transport mechanism for a reactant (diffusion or distribution). If the catalytic layer is, by contrast, not applied onto the gas diffusion layer, but rather onto one or both main surfaces of the PEM, a catalyst coated membrane—CCM for short—is thus spoken of.

Such a manner of fuel cell can, in relatively low operating temperatures, generate electrical power with high output. Actual fuel cells are mostly stacked into so-called fuel cell stacks—stacks for short—in order to achieve a high output, wherein bipolar separator plates, so-called bipolar plates are employed in place of the monopolar separator plates, and monopolar separator plates only form the two terminal ends of the stack. They are sometimes named end plates and can significantly differ in terms of construction from the bipolar plates.

The bipolar plates are generally composed of two partial plates. These partial plates comprise substantially complementary and, with respect to a mirror plane, mirror-imaged shapes. The partial plates must not, however, compulsorily be mirror-imaged. It is merely important that they comprise at least one common contacting surface, at which they can be connected. The partial plates have an uneven topography. The channel structures already mentioned above hereby result on the surfaces of the partial plates respectively facing away from one another. The channel structure complementary to the above-mentioned channel structure exists, for example in embossed metallic partial plates, on the surfaces of the partial plates respectively facing towards one another. In the super-positioning of the two partial plates, a cavity, which consists of a system of multiple tunnels connected with one another, thereby results between the partial plates, on their surfaces facing one towards the other. The cavity or the system of the tunnels is bordered, in a fluid-tight manner, by a joining, substantially surrounding the partial plates in the edge region, wherein openings supply and discharge of coolant are provided, so that the cavity can be used for the distribution of a coolant.

The distribution of oxidizing agent and of reducing agent, the distribution of coolant and thusly the cooling (or better said temperature controlling) of the fuel cells, the fluidic separation of the individual cells of a stack from one another, further the electrical contacting of the cascaded individual cells of a stack, and thus the conducting of the electrical power generated by the individual cells thus belong to the tasks of the bipolar plate.

Separator plates or bipolar plates, accordingly, separate the reactants or reaction gases and the coolant from one another, in fuel cell stacks, and they distribute the reactants and the coolant in the fuel cell reaction region. It is required here that the separator plates are electrically and thermally of good conductivity, as well as robust with respect to chemical influences, in the fuel cell. Moreover, the separator plates shall have a sufficiently high mechanical stability so that they can withstand the mechanical contact pressures in the fuel cell stack. In order to lead the gaseous and/or fluid reactants or media to the individual fuel cells, mostly structures are directly integrated into the separator plates for a corresponding media supply, as well as for the media discharge.

The bipolar plates are very cost-intensive components, and account, in the present state of the production technology, for between 30 percent to 45 percent of the costs of the fuel cell stack. The reasons for this lie in particular in the requirement for the provision of a surface, provided with fine groove structures, in a simultaneously as low as possible wall thickness or residual wall thickness.

Metals, such as stainless steel or titanium or titanium alloys, come into consideration as materials for bipolar plates. Materials for bipolar plates moreover include non-metallic materials like graphite, thermosetting composite materials, thermoplastic composite materials as well as expanded graphite foils.

Bipolar plates from a synthetic material, which is provided with carbon black as filler are, however, brittle and expensive in manufacture. Moreover, metal bipolar plates are also expensive.

The object of the present invention is therefore to bring about a particularly simple and cost-effective method of the aforementioned type, as well as to provide a corresponding separator plate and an intermediate product for such a separator plate.

The object is achieved by a method with the features of patent claim 1, a separator plate with the features of patent claim 9 and an intermediate product with the features of patent claim 10. Advantageous configurations with appropriate further developments of the invention are specified in the dependent patent claims.

A curable and electrically conductive material is applied onto a carrier material in the method according to the invention for manufacturing a separator plate for a fuel cell. A flow-field is formed, in the curable material, for a reactant suppliable to the fuel cell. The material is cured following the forming of the flow-field. The separator plate can be formed by means of the cured material.

In such a manner of production method, one can make use of the findings which can be derived from the production of a so-called transfer paint film known and, for example, described in DE 10 2007 058 714 A1. Consequently, the separator plate allows for particularly simply and cost-effective production, in that the curable material, usable for forming the separator plate, is provided on the carrier material. A highly-productive manufacturing method with particularly low costs is thus achievable.

Moreover, the raw material costs for providing the curable and electrically conductive material are particularly low, in particular lower than the costs for providing material for conventional separator plates or bipolar plates. This also is beneficial to a particularly cost-effective production. Such a production method additionally allows to be scaled in such an easy manner, that very high quantities can be achieved in the production of the separator plates.

In addition, the separator plates can be made available with a particularly small thickness or wall thickness. In a fuel cell stack with a given size, the number of fuel cells can thus be increased. Consequently, a fuel cell stack with an increased energy density can be made available.

Moreover, there is no corrosion, as can arise in metallic separator plates or bipolar plates in the operation of the fuel cells. As a result, a particular long service life of the fuel cells can be achieved. In addition, the properties of the curable and electrically conductive material can be adjusted particularly easily, such that the manufactured separator plate is not brittle. This is also beneficial to a prolonged durability of the separator plate.

In particular the usage of the findings gained in production of the so-called transfer paint film is advantageous for the production of the separator plate. Such a transfer paint film comes into use, for example, as a decorative film for motor vehicle components resistant to weather and resistant with respect to UV light. For example, water deflectors, arranged on the side edge of a windshield of a motor vehicle, can be provided with such manner of transfer paint film.

The basis of the paint film technology is, as a rule, a monolayer or two-layer system. For example, an adhesive water-based layer can be applied onto the carrier material for the production of a two-layer system, which layer can be provided with pigments. A second, solvent-containing layer, for example arcrylate-based, can be arranged onto the adhesive layer, which can be cured in particular through radiation such as UV light and/or heating. Such a transfer paint film, including the carrier material and one or multiple paint layers applied thereon, is preferably produced in a coil-coating process.

Initially, in a first coating step, the adhesive layer or the bonding varnish, which is pigmented in a desired color, is, for this purpose, applied onto the carrier material, in particular a carrier film, from which the bonding varnish later can be detached. The carrier film with the bonding varnish can, if necessary be wound up and intermediately stored. In a second method step, it can be provided, for example, which a solvent-containing, radiation-curable acrylate clear varnish material, which is applied onto the bonded layer. This clear varnish is dried and subsequently cured, preferably with UV light or by means of particle radiation in a matter of seconds. In addition, a protective film can be applied onto the clear paint.

The transfer paint film provided with the protective film can then be used in coating the motor vehicle component. In particular, the transfer paint film can here be made available as roll good and constitute a so-called parent roll. This roll good can be cut to different dimensions for further processing. For example, a metal component, such as for example an aluminum strip can be provided with extruded PVC (polyvinylchloride). The protective film is pulled off from the transfer paint film with the protective film. The surface of the transfer paint film, exposed in this way, can then be applied onto the extruded PVC material. Consequently, the paint layers applied onto the carrier film then are located between the PVC layer and the carrier film, wherein the PVC layer is arranged on the metallic component. The carrier film can then be pulled off, wherein the paint layers remain on the PVC sheet. As a result, the paint layers are thus transferred onto the aluminum strip provided with extruded PVC.

If the separator plate is now produced, as presently, in the manner of such a transfer paint film, the chemical and physical properties of the material forming the separator plate thus can be simply set. In addition, the desired layer thickness and also the desired surface structure, in particular in the form of a flow-field, can be set in the production process in a defined manner.

As a rule, it is sufficient for the present invention to apply a layer of the curable material onto the carrier material. A two- layer system (as described above) is preferably not required within the scope of the present invention.

Preferably, the carrier material provided with the curable material passes through a plurality of processing stations. The flow-field can thus be formed at a processing station and the material can be cured at a further processing station. In particular, a very economical continuous production of the separator plates can thus be achieved. The material can in particular be cured upon application of radiation, in particular with electron radiation or with UV light. The curing can thereby be effected particularly quickly. A thermal curing is also possible. If necessary, a sequential curing, by means of heat and radiation, can be provided, for example upon usage of dual cure paints. A dual cure paint includes at least one component which is thermally curable and at least one further component with is curable by means of radiation, in particular by means of UV radiation. For example, a dual cure paint can include a urethane acrylate resin which can thermally crosslink via hydroxyl or isocyanate groups and can free-radically crosslink via acrylic groups.

It has shown to be of further advantage if the material is dried and/or gelled, at least in sections, before the introduction of the flow-field. In such a gelling, the material consequently is present in a gel-like intermediate state, which is suited for forming the flow-field in the material. The material can be applied with heat to dry. In particular, the material can, through the application with radiation such as UV light or thermally, be precured or partially cured, so that, subsequently, particularly good structural elements or structures, such as the flow-fields, can be introduced into the material.

In particular, it can also be provided to cure the material thermally in one step upon gelation and, in a further, later step, to cure it by means of radiation, in particular by means of UV radiation. In particular the mentioned dual cure paint can be employed to that end. After the thermal curing, structures, such as the flow-field, can still be introduced in such a paint in a problem-free manner through plastic deformation. A final hardening, after which the introduction of structures through plastic deformation is hardly still possible, can then be effected through the radiation of the paint.

Preferably, the flow-field is formed in the material by means of an embossing tool and/or through roll-forming. The flow-field thus can be provided particularly precisely and reproducibly. In addition, the carrier material can continuously pass through the processing station serving to form the flow-field, in particular in roll forming or roll profiling. In the use of an embossing tool for forming the flow-field, it is, by contrast, easier to not further move the carrier material in a conveying direction during the formation of the flow-field.

Preferably, a mixture is used for providing the cured material, which includes at least one synthetic material provided with electrically conductive filler and a solvent. In particular, an epoxy resin and/or an acrylic resin and/or a polyurethane resin and/or a polyester-acrylate resin can be employed as the at least one synthetic material. Moreover, the mixture can comprise at least one photo-initiator, so that the material can be particularly easily cured by means of light, in particular UV light. The processability of the material can be ensured through a corresponding setting of the proportion of solvent and the proportion of solid. Furthermore, the mixture can also include a hardener, for example, in the case of the polyurethane resin, an isocyanate hardener.

The dual core paint can, however, also be employed as synthetic material, for a dual core paint based on the mentioned urethane acrylate resin.

It is essentially also possible to use a solvent-free mixture, which does not have to be dried. This then only includes the electrically conductive filler and the synthetic material. A gelling of such a mixture can be induced through the mentioned pre-curing or partial curing.

If a solvent is used, it here preferably relates to an organic solvent or solvent mixture, for example butyl acetate. It is, however, essentially also possible to employ a water-based resin, for example a water-based polyurethane resin, as synthetic material.

Moreover, the synthetic material is preferably provided with sufficient electrically conductive fillers, such as carbon black or graphite, in particular in a quantity so that an electrical resistance of the material results in a range from around 10 mOhm/cm² to around 30 mOhm/cm². Through usage of such a mixture, the separator plate can be particularly simply produced from the cured material. The mixture can also contain further fillers.

In a preferred embodiment, the mixture includes a carbon-based material, as electrically conductive filler, from the group with activated carbon (AC), activated carbon fiber (AFC), carbon aerogel, graphite, graphene and carbon nanotubes (CNTs).

Activated carbon relates, as is known, to a porous, particularly fine-grain carbon modification with a larger inner surface.

Activated carbon fibers can be sourced from activated carbon. They are likewise porous, comprise a large inner surface and mostly have a typical diameter of around 10 μm. Aside from a high specific capacity, activated carbon fibers comprise an exceptionally good electrical conductivity along the fiber axis.

Carbon aerogel is a synthetic, highly-porous material from an organic gel, in which the fluid component of the gel was replaced, through pyrolysis, with a gas. Carbon aerogels can be manufactured, for example through pyrolysis, from resorcinol-formaldehyde. They comprise a better electrical conductivity than activated carbon.

Graphene can relate to a carbon modification with two-dimensional structure. A plurality of linked benzene rings forms a honeycomb-shaped pattern, in which each carbon atom is surrounded by three further carbon atoms at an angle of 120°, and wherein all carbon atoms are sp2-hybridized. Graphene offers the theoretically-largest surface per unit of weight achievable with carbon.

Carbon nanotubes relate to graphene layers formed into cylindrical nanotubes. There are single-wall nanotubes and multi-wall nanotubes, in which multiple single-wall nanotubes are arranged nested in each other coaxially.

The named carbon-based materials can, of course, also be used in combination with one another. Here, each mixing ratio is conceivable. In a particularly-preferred embodiment, the mixture includes the graphene as electrically conductive material.

It has been shown that, in particular in usage of graphene as an electrically conductive filler, an unexpectedly low quantity of the filler is sufficient for the manufacturing of the separator plates. The proportion of graphene in the mixture preferably lies in the range from 3% by weight to 10% by weight.

In a particularly-preferred embodiment, the mixture includes the following components in the following proportions:
the electrically conductive filler, in particular the graphene, in a proportion from 3% by weight to 30% by weight, preferably from 3% by weight to 20% by weight, particularly preferably from 3% by weight to 10% by weight
the synthetic material, in particular the urethane acrylate resin, in a proportion of 40% by weight to 97% by weight
if necessary, at least one additive to influence the processing properties of the mixture, or the properties of the separator plate to be produced, in a proportion from 0.1% by weight to 10% by weight

In the solvent-containing variants, the mixture in addition includes the solvent or solvent mixture in a proportion from 10% by weight to 50% by weight, preferably from 10% by weight to 30% by weight.

It is preferred in all variants that the weight proportions of the components of the mixture ad up to 100% by weight.

As an additive, photo-initiators, defoamers and flow-control agents, for example, can be added to the mixture.

Additionally or alternatively, it is been shown to be advantageous if a film is used as the carrier material. Preferably, the film consists substantially of synthetic material, in particular of fluoropolymers such as ethylene-tetrafluoroethylene (ETFE), polyethylene- terephthalate, polyolefin, polycarbonate, acrylonitrile-butadiene-styrene (ABS), acryl-styrene-acrylonitrile (ASA), acrylonitrile-butadiene-styrene/polycarbonate (ABS/PC), acryl-styrene-acrylonitrile/ polycarbonate (ASA/PC), polyacrylate, polystyrene, polycarbonate/polybutylene-terephthalate (PC/PBT) and/or polymethylmethacrylate.

In particular, a polyester film can be employed as the carrier material, preferably a biaxially-oriented or biaxially-stretched polyester film. For example, a PET film (PET=polyethylene-terephthalate) can be used, which is obtainable from the manufacturer DuPont under the designation “Mylar A”. Such a carrier material suits itself well to the application of the curable material and is suitable in particular for the passing-through of multiple processing stations in the manufacturing of the separator plate due to its high tensile strength.

Preferably, the carrier material is provided as a continuous material web, wherein, to manufacture the separator plate, at least one region is separated out from the carrier material provided with the cured material. Simply the openings or passages which serve as fuel inlet, fuel outlet, oxidizing agent inlet, oxidizing agent outlet, as well as coolant inlet and coolant outlet can thus be provided in the material forming the separator plate. Moreover, a desired outer contour of the separator plate can be specified, for example. The separating out can result through punching and/or cutting, in particular laser-cutting, and the like.

Preferably, the cured material is provided in a thickness of around 50 μm to 150 pμm on the carrier material. In particular, if the cured material comprises a thickness of 100 μm and less, for example around 90 μm, 80 μm, 70 60 μm or 50 μm, a very advantageous ratio of a thickness of the material to a height or depth of grooves or the like structures permits itself to be set, which form the flow-field. In addition, a low thickness of the cured material leads to a diminishing of the material amount to be made available. What is more, a time for drying and/or curing of the materials can be substantively reduced.

It is preferred that the cured material does not comprise any thermoplastic properties, that is, a reversible plastic deformation or heating of the cured material is not possible any longer.

The cured material is preferably detached from the carrier material to make the separator plate available. In particular, a partial plate can be made available, in this way, which can form the separator plate or bipolar plate through connecting with a further partial plate. Consequently, the cavity provided between the partial plates can form a coolant flow-field. Through the detaching of the cured material from the carrier material, it can be ensured, in a particularly simple way, that the separator plate is electrically conductive.

The invention also relates to a separator plate for a fuel cell, wherein the separator plate is obtainable through the method according to the invention. Moreover, the invention relates to an intermediate product for such a separator plate, in which the cured material is arranged on the carrier material. The carrier material with the cured material can, in particular, provide the intermediate product or semi-finished product, in the form of a roll, wherein the plate-shaped parts, in particular partial plates, desired for the producing of the separator plates, can be simply separated out of the roll.

The advantage and preferred embodiments, described for the method according to the invention, also apply for the separator plate according to the invention and the intermediate product according to the invention, and vice versa.

The separator plate according to the invention and the intermediate product according to the invention preferably distinguishes themselves thereby in that they include a matrix of the above-mentioned cured material, which does not comprise any more thermoplastic properties, in which matrix the electrically conductive filler, particularly the graphene, is embedded. In accordance with above description, the proportion of the electrically conductive filler, particularly preferably of the graphene, is at least 3% by weight. In further preferred embodiments, the proportion lies in the range from 3% by weight to 40% by weight, preferably from 3% by weight to 30% by weight, particularly preferably from 3% by weight to 20% by weight, in particular from 3% by weight to 12% by weight.

Further advantages, features and details of the invention result from the following description of a preferred exemplary embodiment, as well as based on the drawings. The features and feature combinations precedingly named in the description, as well as, following, the features and feature combinations named in the description of figures and/or shown in the figures alone, are usable not only in the respectively specified combination, but also in other combinations or alone, without departing from the scope of the invention.

The Figures show in:

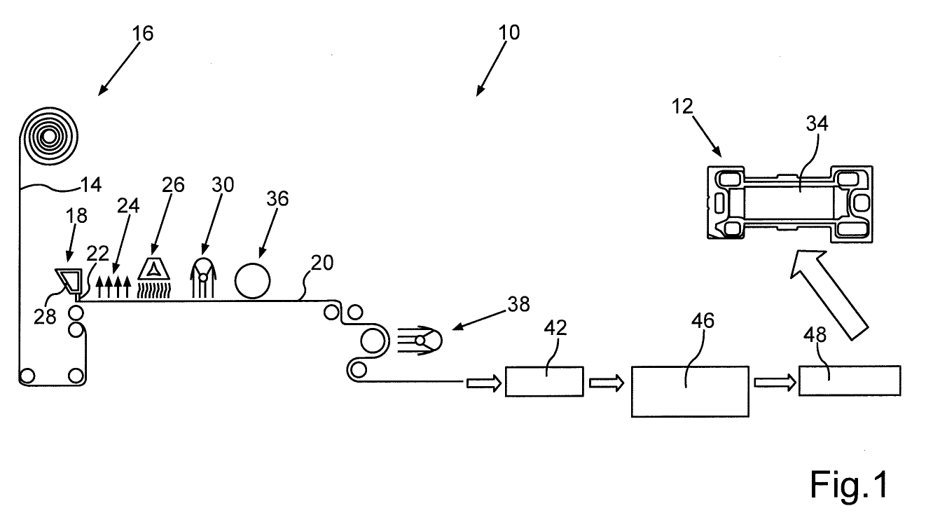

FIG. 1 schematically a production plant for manufacturing bipolar plates for fuel cells of a fuel cell stack, and

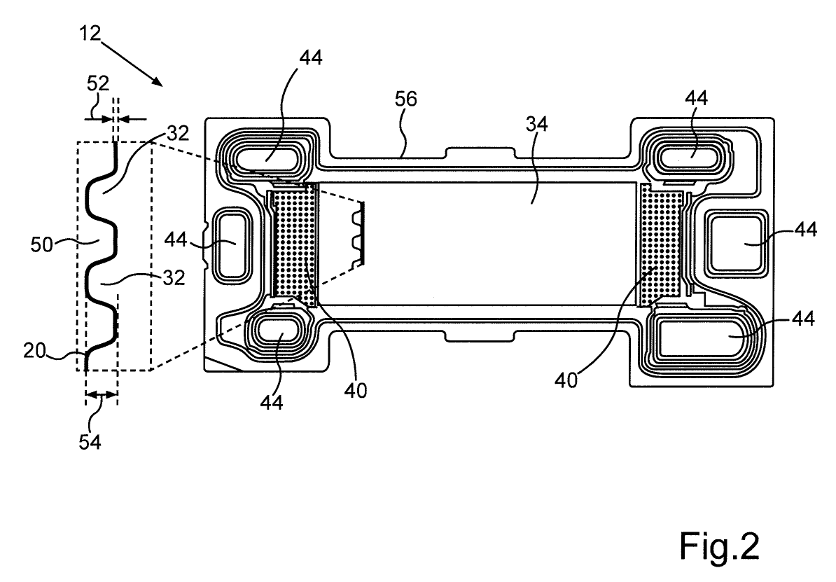

FIG. 2 an enlarged plan view of a manufactured bipolar plate.

A production plant 10, schematically shown in FIG. 1, serves the production of separator plates, wherein a bipolar separator plate, in the form of a bipolar plate 12, is shown in FIG. 2 in a plan view, which plate can be manufactured in the production plant 10. The bipolar plates 12 are provided for fuel cells of a fuel cell stack, as can come into use in a motor vehicle, for example.

Initially, a carrier material, presently in form of a carrier film 14, is provided in the production of the bipolar plates 12. Here, the carrier film 14 can be present wound up into a roll 16. In particular, a biaxially-stretched or biaxially-oriented polyester film can come into use as carrier film 14.

The carrier film 14 is unwound from the roll 16, and subsequently supplied to further processing stations of the production plant 10, At a first processing station 18, a mixture 28 is applied onto the carrier film 14, which mixture includes an electrically conductive material 20, wherein the material 20 can be cured. For example, the carrier film 14 can be applied with the mixture 28 via a slot nozzle 22 or the like application device, which mixture includes an epoxy resin and/or acrylic resin, at least one solvent, photo-initiators and electrically conductive fillers, such as carbon black and/or graphite. What is more, the mixture 28 can also comprise further fillers. A venting of the solvent from the mixture 28 occurs at a subsequent processing station 24. The consistency of the of material 20 thereby changes. The venting can, for example, be carried out over around a minute.

In particularly preferred embodiments, a mixture out of the following components can also be used as a mixture 28, instead of the mixture with the epoxy resin and/or the acrylic resin:
9.4% by weight of a double-bond containing polyol (solvent-free) with an OH content of 5.7% and a double-bond density of 3.5 mol/kg
28.2% by weight of a double-bond containing urethane acrylate (solvent-free) with a NCO content of 5.4% and a double-bond density of 1.5 mol/kg
28.2% of a double-bond containing urethane acrylate (solvent-free) with a glass transition temperature of 2° C. (established by means of differential scanning calorimetry at a heating rate of 10° C/min) and a double-bond density of 4 mol/kg
1.4% by weight of a commercially-available photo initiator
0.5% by weight of a commercially-available flow-control agent
1.0% by weight of a commercially-available defoamer
25.3% by weight butyl acetate
6% by weight graphene

The mixture 28 or material 20 is subsequently pre-dried, for example by means of a heating unit 26, which mixture/material is applied onto the carrier film 14. The application of the mixture 28 with heat at the heating unit 26 leads presently to a gelling or dry-hardening of the mixture 28 or of the material 20. The material 30 can additionally be partially-cured or pre-cured at a subsequent, optional processing station 30. For this purpose, the material 20 can be applied with light, in particular with UV light at the processing station 30.

Subsequently, structures are formed in the dry-hardened or partially-cured material 20, e.g. in the form of channels 32 (see FIG. 2), which form a flow-field 34 in the completed bipolar plate 12. Through a corresponding setting of the proportion of the solvent and the solids in the mixture 20, it can be achieved that desired surface structures can be formed in the pre-dried or dry-hardened and/or, through UV light at the processing station 30, partially cured material 20.

To form the surface structures of the bipolar plate 12 including the flow-field 34, an in particular two-piece embossing tool can find use as a tool 36. Additionally or alternatively, this structuring can be undertaken through a tool 36 suited for roll forming or roll-profiling. In particular, the channels 32 or groove structures can, in this way, be formed in the material 20.

The flow-field 34 (see FIG. 2) formed by means of the corresponding tool 36 enables a (not shown) membrane electrode assembly of the fuel cell to be applied with a reactant, for example with hydrogen as fuel or with oxygen or air as an oxidizing agent. Moreover, structural elements can be provided on surface structures by means of the tool 36, which elements are provided, in the bipolar plate 12, in a respective transition region 40 between the flow-field and corresponding inlets or outlets, for the reactants involved in the fuel cell reaction (see FIG. 2).

Due to the provisioning of the photo-initiators in the mixture 28, the material 20 can be completely cured in a subsequent processing step. For this purpose, a corresponding light source 38, in particular UV light source, is provided at a further processing station. After the curing of the material 20, e.g. by means of the UV light emitted by the light source 38, the corresponding structures are permanently formed in the material 20.

In a subsequent processing step, a plurality of though-passages 44 can be formed in the material 20, for example through punching 42 (see FIG. 2). A fuel cell inlet and a fuel cell outlet, an oxidizing agent inlet and an oxidizing agent outlet, as well as a coolant inlet and a coolant outlet are usually provided through such through-passages 44. These through-passages 44 form corresponding channels for supplying and discharging of the reactants or of the coolant, in the fuel cells stacked on top of each other.

An outer contour 56 of the bipolar plate 12 can be manufactured, as desired, in a subsequent processing step or at a subsequent processing station, by cutting 46. In particular a laser or the like can come into use for the cutting 46. Moreover, regions can be removed from the cured material 20 by means of a laser, in order to form desired structures in the bipolar plate 12.

The material 20, moreover, is connectable, through a suitable joining method, in particular through adhesion, with a further part formed out of the material 20, as precedingly described. Consequently, a first partial plate of the bipolar plate 12 can be provided through the material 20, which plate can be connected with a second partial plate of the bipolar plate 12 through joining 48. In this way, a flow-field for a coolant can be provided in cavity or intermediate space 50 between two such partial plates (comparison FIG. 2).

Preferably, a thickness 52 of the cured material 20 (see FIG. 2) is very low. In particular, the thickness 52 is preferably significantly less than a depth 54 of the grooves or channels 52, which are formed, in the region of the flow-field 34, for the reactant or, in the region of the flow-field, for the coolant.

Moreover, the material 20 is sealed with respect to air or oxygen and with respect to hydrogen. In addition, the material 20 comprises a corresponding mechanical strength and structural integrity for the providing of the bipolar plates 12, which are meant to come into use in the fuel cells of the fuel cell stack. The electrical resistance is set, through suitable fillers, such as the carbon black particles or graphite particles, such that the material 20 comprises a good electrical conductivity. For example, the electrical resistance of the material 20 can lie in the range from 10 mOhm/cm² to 30 mOhm/cm².

The carrier film 14 provided with the cured material 20 can also be provided, initially, as intermediate product or semi-finished product before its final form is conferred through corresponding further processing steps, such as the punching 42, the cutting 46 or the joining 48 of the bipolar plates 12. The intermediate product can in particular be wound up into a roll.

Moreover, it can be provided that regions, such as the through-passages 44, can be separated out of the carrier film 14 provided with the cured material 20, and thus an intermediate product or semi-finished product surrounding the carrier film 14 with the cured material 20 is made available and is wound up, in particular into a roll. The bipolar plate 14 with a desired outer contour 56 can then be formed from such an intermediate product through a cutting 46 and joining 48, after a detaching of the material 20 from the carrier film 14. In particular, the intermediate product can initially be cut and, after the detaching of the material 20 from the carrier plate, the bipolar plate 12 can be formed through joining of the thus-obtained partial plates.

1-11 (canceled)

12. A method for manufacturing a separator plate for a fuel cell, in which a curable and electrically conductive material is applied onto a carrier material at a first processing station, wherein a flow-field for a reactant suppliable to the fuel cell is formed in the material, and wherein the material is cured following the forming of the flow-field,
characterized in that
the carrier material, provided with the curable material, passes through a plurality of processing stations, in that
the material is, at least in regions, dried and/or gelled and/or precured before the introduction of the flow-field at the respective processing station, and in that
the flow-field is subsequently formed in the material by means of an embossing tool and/or through roll-forming.

13. The method according to claim 12, characterized in that the material is, at least in regions, dried, and is subsequently gelled and/or precured
before the introduction of the flow-field at the respective processing station.

14. The method according to claim 12, characterized in that
the material (20) is curable through application with UV light.

15. The method according to claim 13, characterized in that
the material (20) is curable through application with UV light.

16. The method according to claim 12, characterized in that the material is precured through application with UV light.

17. The method according to claim 13, characterized in that the material is precured through application with UV light.

18. The method according to claim 14, characterized in that the material is precured through application with UV light.

19. The method according to claim 15, characterized in that the material is precured through application with UV light.

20. The method according to claim 12, characterized in that to provide the cured material, a mixture, comprising at least one synthetic material provided with an electrically conductive filler, in particular an epoxy resin and/or an acrylate resin, and including a solvent, in particular comprising at least one photo-initiator, is used and/or a film, in particular a preferably biaxially-oriented polyester film, is used.

21. The method according to claim 13, characterized in that to provide the cured material, a mixture, comprising at least one synthetic material provided with an electrically conductive filler, in particular an epoxy resin and/or an acrylate resin, and including a solvent, in particular comprising at least one photo-initiator, is used and/or a film, in particular a preferably biaxially-oriented polyester film, is used.

22. The method according to claim 14, characterized in that
to provide the cured material, a mixture, comprising at least one synthetic material provided with an electrically conductive filler, in particular an epoxy resin and/or an acrylate resin, and including a solvent, in particular comprising at least one photo-initiator, is used and/or a film, in particular a preferably biaxially-oriented polyester film, is used.

23. The method according to claim 15, characterized in that
to provide the cured material, a mixture, comprising at least one synthetic material provided with an electrically conductive filler, in particular an epoxy resin and/or an acrylate resin, and including a solvent, in particular comprising at least one photo-initiator, is used and/or a film, in particular a preferably biaxially-oriented polyester film, is used.

24. The method according to claim 20, characterized in that
the mixture includes the electrically conductive filler, preferably graphene, in a proportion from 3% by weight to 30% by weight, preferably from 3% by weight to 20% by weight, particularly preferably from 3% by weight to 10% by weight.

25. The method according to claim 12, characterized in that
the carrier material is provided as a continuous material web, wherein at least one region is separated out of the carrier material provided with the cured material to manufacture the separator plate.

26. The method according to claim 12, characterized in that
the cured material is provided in a thickness from around 50 μm to around 150 μm on the carrier material.

27. The method according to claim 13, characterized in that the cured material is provided in a thickness from around 50 μm to around 150 μm on the carrier material.

28. The method according to claim 12, characterized in that the cured material is detached from the carrier material for providing the separator plate.

29. The method according to claim 13, characterized in that
the cured material is detached from the carrier material for providing the separator plate.

30. A separator plate for a fuel cell, wherein the separator plate is obtainable by the method according to claim 12.

31. An intermediate product for a separator plate according to claim 30, wherein the cured material is arranged on the support material.
